(19) United States
(12) Patent Application Publication
(10) Pub. No.: US 2008/0182005 A1
(43) Pub. Date: Jul. 31, 2008

(54) Floating aquatic gel

(75) Inventors: Kent J. Lanter, Waterloo, IL (US); Mark E. Griffin, Pacific, MO (US)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: Land O'Lakes Purina Feed LLC, Shoreview, MN (US)

(21) Appl. No.: 11/657,945

(22) Filed: Jan. 25, 2007

(51) Int. Cl. A23K 1/00

(52) U.S. Cl. 426/561

(57) ABSTRACT

A method of forming an aquatic gel by forming a gelling component containing a gelling agent and a gas-forming agent, providing an acidic component containing an acidic agent in combining the gelling component and the acidic component with water at an elevated temperature and then permitting the mixture to set and form a gel. The combination of the acidic component, the gelling component and water is effective to form gas bubbles in the gel such that a density of less than about 1.0 g per ml is created.

### CROSS-REFERENCE TO RELATED APPLICATION

None

### BACKGROUND OF THE INVENTION

The present invention generally relates to a non-human animal feed gel. More specifically, the present invention relates to an aquatic feed gel that is capable of floating or remaining suspended in water for an extended time period. The present invention further relates to methods of making the aquatic feed gel.

The many and varied aquatic gardens of the world are responsible for the breeding and care of a wide assortment of aquatic animals. The feeding of these aquatic animals is a major expense in the operation of these gardens, and it can often prove to be a logistical challenge. Depending upon the type, size and number of animals, insuring that each aquatic animal receives a properly balanced diet in a timely and efficient manner requires careful planning, reliable food sources, and trained personnel.

In an effort to diminish the problems associated with the feeding of such animals, the operators of these gardens and similar establishments, such as breeding farms, or entertainment facilities continuously search for manufactured feeds to replace natural feeds. Manufactured feeds are generally less expensive, available in bulk quantities, generally easier to transport and store, less fungible, and often easier to tailor with respect to nutritional content than natural feeds.

Animal feed gels are conventionally produced by pouring a mixture having at least one gelling agent, at least one protein source and water into a mold, allowing the mixture to set, and then removing the gel from the mold for packaging, shipping, storage and or use. The finished gel product should have sufficient structural integrity so that it can be handled in a routine manner without breakage, such as not breaking when fed by hand to an animal.

In the past, there has been considerable waste of aquatic food supplied for feeding aquatic animals in rearing tanks and ponds in hatcheries and fisheries because of one or more undesirable characteristics of the aquatic food. For example, feed texture is important for many aquatic animals. When the aquatic food is supplied in pellet form, the pellets may be too hard to be palatable to the aquatic animal and consequently is rejected by them. Other pellets may be so dense that they sink too quickly to the bottom of the tank or pond where they are lost to the aquatic animal.

### SUMMARY OF THE INVENTION

The present invention includes a method of forming an aquatic gel by forming a gelling component containing a gelling agent and a gas-forming agent, providing an acidic component containing an acidic agent, combining the gelling component and the acidic component with water at an elevated temperature and then permitting the mixture to set and form a gel, the combination of the acidic component, the gelling component and water effective to form gas bubbles in the gel, and the gel having a density of less than about 1.0 g per ml.

### DETAILED DESCRIPTION

The present invention relates to an aquatic feed gel that floats or remains suspended in water for an extended period of time. The aquatic feed gel includes a gelling component, an acidic component, water, and has a density that is less than about 1 g per ml. As a result, the aquatic gel is capable of floating or remaining suspended on water for a time period of at least 5 minutes and between about 5 minutes to about 20 minutes.

Initially, a gelling agent, such as gelatin is mixed with a gas-forming agent, such as calcium carbonate to form a gelling component. Alternatively, the gelling agent may be a combination of locust bean gum and carageenan or a combination of gelatin and xanthan gum. The gelling agent(s) typically have a concentration of about 0.5 to about 20 weight percent, based on the total weight of the aquatic feed gel. The gas-forming agent used to practice the present invention has a concentration of about 1 weight percent to about 2 weight percent, based on the total weight of the aquatic feed gel.

Although reference is made to gelling agents, such as gelatin, carageenan, locust bean gum and xanthan gum, any suitable edible material that is capable of (1) forming a three dimensional network or gel, (2) providing structural integrity to the aquatic feed gel, (3) minimizing loss of gas bubbles from the aquatic mixture, and/or (4) impeding separation of components in the aquatic feed gel may be used as the gelling agent(s) of the present invention.

Some non-exhaustive examples of other suitable gelling agents include alginates, such as sodium alginate, calcium alginate, potassium alginate, ammonium alginate, propylene glycol alginate, or any combination thereof, agar, kauri, gum Arabic, tragacanth, pectin, locust bean, carrageenan or any combination of any of these.

Alternatively, feed additives that provide nutrients, energy and vitamins, minerals to the animal may be combined with the gelling agent when forming the gelling component. Feed additives are typically a mixture of carbohydrates, protein, vitamins, minerals, and/or fat and may be added at a concentration of no more than about 25 weight percent, based on the total weight of the feed gel. Both the gelling agent and optional feed additives are supplied in dry form when practicing the present invention. 5M70 Aquarium Gel that is available from Land O'Lakes Purina Feed, LLC of St. Louis, Mo. is an example of a feed that is suitable for use in the present invention.

Next, the gelling component is mixed with water that has been brought to a boil to form a gel slurry.

Water is typically included at a concentration of at least about 70 weight percent but can be made with as low as 50 weight percent water and preferably within a weight range of about 70 to 75 weight percent, based on the total weight of the aquatic feed gel. Next, an acidic component containing an acidic agent, such as citric acid is rapidly blended into the gel slurry to form a gel mixture. By rapidly is meant the addition of the acidic component is completed in about 5 to about 10 seconds. The acidic component may also optionally include one or more feed additives to help provide a balanced diet to the animal. The optional feed additive(s) also contain protein, fat, carbohydrates and/or vitamins and minerals. As noted, when feed additives are included as part of the feed gel, the concentration is generally less than about 25 weight percent, based on the total weight of the feed gel when practicing the present invention.

When the gas-forming agent mixes with the acidic agent, gas bubbles are formed. To retain as many gas bubbles as possible and to retain the gas bubbles in an even distribution throughout the gel, the gel is set as quickly as possible. Once the bubbles are formed, the bubbles tend to move upwardly through the gel mixture. If the gel's viscosity is not sufficiently high or the gel is not set quickly enough, the bubbles will move upwardly before the gel is set resulting in an uneven distribution of bubbles within the volume of gel being formed. The uneven distribution of bubbles through the volume of gel being formed may make the density of the gel in the lower sections of the gel greater than water causing those sections to become sinking, when the volume of gel is cut into sections.

By rapid is meant gas bubbles are produced in about 5 to about 10 seconds. The gel mixture is typically mixed with a spatula or the like for about 5 to about 10 seconds. However, up to 30 seconds may be needed depending on the viscosity of the gel and how quickly the gas forming agent solubilizes. For example, different grades of calcium carbonate have different solubility rates. Also coating the calcium carbonate with for example oil can also slow the solubility of calcium carbonate. Therefore the formation of bubbles can be controlled to some extent. Alternatively, mixing is accomplished using a Hobart mixer when practicing the present invention. In addition, although a small portion of gas bubbles may escape from the gel mixture during mixing, a substantial portion of the gas bubbles remain entrapped within the gel mixture. In addition to calcium carbonate, magnesium carbonate or magnesium bicarbonate would also be suitable as a gas forming agent.

After mixing, the gel mixture is cooled to refrigeration temperatures in the case where gelatin is the major gelling agent and to a temperature of less than about 140°F. when the gelling agent is a combination of carageenan and locust bean gum. Cooling the gel mixture sets the gel mixture and forms an aquatic feed gel having a density that is less than about 1 g per ml. When the gel sets, the bubbles become voids or, spaces which reduces the density and aids the buoyancy of the aquatic feed gel so that the gel remains suspended on water for an extended period of time.

Additionally, prior to cooling, the gel mixture may be rapidly spread into a thin layer having a thickness of no more than about 1 inch so that the gel mixture cools as quickly as possible and maximum retention of bubbles in a more even distribution can occur. When the thickness is greater than 1 inch, gas bubbles tend to concentrate at top surfaces of the gel rather than being substantially distributed throughout the thickness of the gel. As a result, if the gel is cut into smaller pieces for feeding, some pieces of the feed gel may not have a sufficient number of bubbles and will sink in water. Quickly cooling or setting the gel helps in a more even distribution of bubbles so that the density of the gel feed is less than water throughout the volume of gel being formed. Increasing the viscosity of the gel also tends to slow migration of the bubbles upwardly. However, increasing viscosity means additional gelling agent which adds to the cost of the feed.

Alternatively, the gel mixture is rapidly poured into individual molds. For example, the gel mixture is poured or placed into a mold within about 10 seconds or less when practicing the present invention. After cooling and setting, the gel may be cut, additionally shaped and placed into packaging material for transportation purposes.

When the density of the aquatic feed gel is less than about 1 g per ml, the aquatic feed gel is capable of remaining suspended in or floating in a volume of water for an extended period of time. For example, an aquatic feed gel having a density of about 0.95 g per ml can be formed when practicing the present invention. The gas bubbles impart buoyant properties to the aquatic feed gel, such that the aquatic feed gel is capable of floating or remaining suspended in water for about 5 minutes to about 20 minutes. The buoyant properties, and therefore the density of the aquatic feed gel can be modified by adjusting the (1) gelling component, (2) acidic component, (3) amount and temperature of water, (4) mixing conditions used to form the gel mixture, (5) the setting conditions and/or (6) viscosity of the gel mixture.

The following examples are illustrative only and not intended to limit the present invention.

### EXAMPLES 1

Approximately 2210 grams of 5M70 aquatic meal that is available from Land O'Lakes Purina Feed, LLC of St. Louis, Mo. was mixed using a Hobart mixer with approximately 182 grams of Ticagel 550 PT from TIC gums of Belcamp, Md., and approximately 208 grams of calcium carbonate to form about 2600 grams of a gelling component. In addition, approximately 2340 grams of 5M70 aquatic meal was mixed using a Hobart mixer with about 260 grams of citric acid to form about 2600 grams of an acidic component. After the gelling component and acidic component were prepared, about 100 grams of water was brought to a boil and removed from the heat.

Next, approximately 20 grams of the gelling component were combined with about 100 grams of hot water was mixed by hand with a spatula approximately 1½ minutes to form a gel slurry. After mixing, about 20 grams of the acidic component was mixed into the gel slurry for about 5 to about 10 seconds to form the gel mixture. Gas bubbles were generated in the warm gel mixture when the citric acid reacted with the calcium carbonate. The warm gel mixture was quickly poured onto a cold surface on a counter top surface so that a thickness of less than 1 inch thick was attained in the gel mixture. When the gel mixture cooled to below 140°F., the gel mixture set to form an aquatic feed gel containing gas bubbles substantially distributed throughout the aquatic feed gel. The aquatic feed gel was allowed to cool to room temperature and cut into smaller pieces.

Next, the degree of float of the aquatic feed gel was determined by putting the cut pieces of the aquatic feed gel into a volume of water and measuring the time it takes for the aquatic feed gel to sink to the bottom of the water. The pieces of aquatic feed gel floated for about 5 to 20 minutes before reaching the bottom of the water.

### EXAMPLE 2

Approximately 15.6 grams of 5M70 aquatic meal was mixed with about 2.4 grams of gelatin, 0.4 grams of xanthan gum and approximately 1.6 grams of calcium carbonate to form approximately 20 grams of a gelling component. Furthermore, approximately 18 grams of 5M70 was mixed with approximately 2 grams of citric acid to form approximately 20 grams of an acidic component. Next, 100 grams of water was brought to a boil. The gelling component was added to the hot water and mixed for about 1½ minutes with a spatula to form the gel slurry. After mixing, approximately 20 grams of the acidic component was added to the gel slurry and mixed for 5 to 10 seconds to form the gel mixture. Gas bubbles were formed in the warm gel mixture when the citric acid reacted with the calcium carbonate. After forming the gel mixture, the gel mixture was poured into a number of plastic cups having a depth thickness of less than about 1 inch. After cooling the gel mixture in the plastic cups to below a temperature of about 40°F. in a refrigerator, the gel mixture solidified and formed the aquatic feed gel containing gas bubbles with the bubbles distributed substantially throughout the aquatic feed gel.

Next, the degree of float of the solidified gel was determined. The solidified gel was cut into smaller pieces and placed into a cup of water. The amount of time required before the pieces of gel sank to the bottom of the water was recorded. The solidified gel pieces floated for about 5 to 20 minutes before reaching the bottom of the water.

Although the present invention has been described with reference to preferred embodiments, workers skilled in the art will recognize that changes may be made in form and detail without departing from the spirit and scope of the invention.

What is claimed is:

1. A method of forming a floatable aquatic gel, the method comprising:
providing a gelling component comprising a gelling agent and a gas-forming agent;
providing an acidic component comprising an acidic agent;
combining the gelling component and the acidic component with water at an elevated temperature to form a mixture; and
permitting the mixture to set and form a gel and wherein the combination of the acidic component, the gel component and water effective to form a plurality of gas bubbles in the gel and the gel having a density of less than about 1.0 g per ml.

2. The method of claim 1 and further including cooling the mixture such that the mixture sets and forms the gel upon cooling.

3. The method of claim 1 wherein water has a concentration of at least 70% by weight of the aquatic gel.

4. The method of claim 1 wherein water has a concentration of at least 50% by weight of the aquatic gel.

5. The method of claim 1 wherein the gelling component and the acidic component includes fish meal comprising protein, fat and starch.

6. The method of claim 1 wherein the gelling component is Carrageenan or Locust bean gum and the aquatic gel is set by reducing the temperature of the aquatic gel to less than about 140°F.

7. The method of claim 1 wherein the gelling component includes gelatin.

8. The method of claim 7 wherein the mixture is cooled to refrigeration temperatures to set the gel.

9. The method of claim 1 wherein the density of the mixture is reduced while forming the gel until the density reaches less than about 1.0 g per ml.

10. The method of claim 9 wherein the mixture is spread to form a gel comprising a thickness of less than about 1 inch.

11. The method of claim 1 wherein the acidic component or the gelling component includes a protein component, a carbohydrate component and a fat component.

12. The method claim 1 wherein the gas-forming agent comprises sodium carbonate, calcium carbonate, potassium carbonate, sodium bicarbonate, potassium bicarbonate, or any combination thereof.

13. The method of claim 1 wherein the acidic component comprises an organic acid.

14. The method of claim 1 wherein the gelling component is a concentration of about 0.5 to about 30 weight percent based on the total weight of the aquatic gel.

15. A product produced by the method of claim 1 and characterized by the aquatic gel remaining suspended on water for at least 30 seconds.

16. A product produced by the method of claim 1 and characterized by the aquatic gel remaining suspended on water for at least 5 minutes.

17. A product produced by the method of claim 1 wherein the aquatic gel remains suspended on water between about 5 minutes and 20 minutes.

18. The method of claim 1 wherein the gelling component includes up to 25% by weight nutritional components.
